(19) United States
(12) Patent Application Publication
(10) Pub. No.: US 2009/0142556 A1
(43) Pub. Date: Jun. 4, 2009

(54) PROCESS FOR FORMING AN ORGANIC ELECTRONIC DEVICE INCLUDING AN ORGANIC DEVICE LAYER

(75) Inventors: Charles D. Lang, Goleta, CA (US); Dmitry Kolosov, Goleta, CA (US); Johann Thomas Trujillo, Goleta, CA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/323,866

(22) Filed: Nov. 26, 2008

Related U.S. Application Data
(60) Provisional application No. 60/990,962, filed on Nov. 29, 2007.

(51) Int. Cl. B32B 3/10; B05D 3/06

(52) U.S. Cl. 428/195.1; 427/553

(57) ABSTRACT

A process of forming an electronic device is disclosed. An organic device layer is formed. The organic device layer includes a charge-selective material and a radiation sensitizer and has a first electrical conductivity. First portions of the organic device layer are selectively exposed to radiation. The electrical conductivity of the first portions of the organic device layer is modified.

### RELATED APPLICATION DATA

This application claims priority under 35 U.S.C. § 119(e) from Provisional Application No. 60/990,962 filed on Nov. 29, 2007 which is incorporated by reference in its entirety.

### BACKGROUND INFORMATION

1. Field of the Disclosure

This disclosure relates in general to processes for forming organic electronic devices. More particularly, the disclosure relates to forming a device layer and selectively modifying the conductivity of the layer over a portion thereof.

2. Description of the Related Art

Electronic devices, including organic electronic devices, continue to be more extensively used in everyday life. Forming circuits in such electronic devices includes forming conductive pathways in organic layers such as those that lie between electrodes of the electronic device. One method to define the conductive pathway is to form a conductive structure by removing portions of a previously formed conductive layer. Another method is to print the conductive structure using a selective deposition technique. Insulating material can be deposited between such conductive structures to provide electrical insulation and planarization. When the insulating material is blanket deposited, openings are made in the insulating layer such that the conductive structures can be electrically connected to form conductive pathways. Another method is to form a well within bank structures such that a conductive liquid deposited over the bank structures collects in the wells to form conductive structures. However uniform formation and fill of many individual structures can be difficult to control.

Improved methods for defining conductive pathways are desired.

### SUMMARY

In a first aspect, a process of forming an electronic device can include forming an organic device layer that includes a charge-selective material and a radiation sensitizer, the device layer having an electrical conductivity, and selectively modifying the organic device layer, wherein the electrical conductivity of a first portion of the organic device layer is modified.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

FIG. 1 includes a diagram illustrating contact angle.

FIG. 2 includes an illustration of a cross-sectional view of a workpiece including a substrate, electrodes, and a charge-selective layer.

FIG. 3 includes an illustration of a cross-sectional view of the workpiece of FIG. 2 while selectively modifying a portion of the charge-selective layer.

FIG. 4 includes an illustration of a cross-sectional view of the workpiece of FIG. 3 after forming a charge-selective layer and an organic active layer.

FIG. 5 includes an illustration of a cross-sectional view of the workpiece of FIG. 4 after forming a substantially complete electronic device.

FIG. 6 includes an illustration of a cross-sectional view of workpiece formed in accordance with a particular embodiment.

FIG. 7 includes an illustration of a cross-sectional view of a workpiece formed in accordance with another particular embodiment.

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

An electronic device can include an organic device layer. In a first aspect, a process of forming an electronic device can include forming an organic device layer that includes a charge-selective material and a radiation sensitizer, and selectively modifying the organic device layer, wherein the electrical conductivity of a first portion of the organic device layer is modified.

In one embodiment of the first aspect, forming the organic device layer can include forming a charge-selective film, and selectively modifying the organic device layer is performed before forming another film on the charge-selective film. In another embodiment, selectively modifying the organic device layer can include selectively exposing the organic device layer to a wavelength of radiation having a value not greater than 360 nm. In still another embodiment, selectively modifying the organic device layer can be performed at a peak intensity of at least 10 J/cm² at a surface within the first portion of the organic device layer.

In another embodiment of the first aspect, the charge-selective material is a large molecule material.

In another embodiment of the first aspect, the charge-selective material is a hole-transport material.

In another embodiment of the first aspect, the process further comprises forming a chemical containment pattern over the organic device layer to define pixel openings.

In a particular embodiment, selectively modifying the organic device layer further includes placing a stencil mask between a radiation source and a charge-selective film of the organic device layer, and selectively exposing the charge-selective film such that substantially unattenuated radiation reaches a first portion of the charge-selective film and attenuated radiation is substantially prevented from reaching a second portion of the charge-selective film. In a more particular embodiment, forming the charge-selective film includes forming a charge-transport film. In another more particular embodiment, after selectively exposing the charge-selective film, the first portion of the charge-selective film has a lower conductivity than the second portion of the charge-selective film.

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Radiation Sensitizer, the Organic Device Layer, the Chemical Containment Pattern, Fabrication of an Electronic Device, the Other Device Layers, Alternative Embodiments, Advantages, and Examples.

### 1. Definitions and Clarification of Terms

Before addressing details of embodiments described below, some terms are defined or clarified.

The term “charge-blocking,” when referring to a layer or material, is intended to mean such layer or material reduces the likelihood that a charge migrates into another layer or material.

The term “charge-injecting,” when referring to a layer or materials intended to mean such layer or material promotes charge migration into an adjacent layer, material.

The term “charge-selective,” is intended to mean charge-blocking, charge-injecting, charge-transport, or any combination thereof.

The term “charge-transport,” or “charge-transporting” when referring to a layer or material is intended to mean such layer or material facilitates migration of such charge through the thickness of such layer or material with relative efficiency and small loss of charge. Although light-emitting materials may also have some charge transport properties, the term “charge transport layer, material, member, or structure” is not intended to include a layer, material, member, or structure whose primary function is light emission.

The term “chemical containment pattern” is intended to mean a pattern that contains or restrains the spread of a liquid material by surface energy effects rather than physical barrier structures. The term “contained” when referring to a layer, is intended to mean that the layer does not spread significantly beyond the area where it is deposited. The term “surface energy” is the energy required to create a unit area of a surface from a material. A characteristic of surface energy is that liquid materials with a given surface energy will not wet surfaces with a lower surface energy.

The term “electrical conductivity” is intended to indicate a measure of a material's ability to conduct an electric current. When an electrical potential difference is placed across a conductor, its movable charges flow, giving rise to an electric current.

The term “large molecule,” when referring to a compound, is intended to mean a compound, which has repeating monomeric units. In one embodiment, a large molecule has a molecular weight greater than 2,000 g/mol.

The term “layer” is used interchangeably with the term “film” and refers to a coating covering a desired area. The term is not limited by size. The area can be as large as an entire device or as small as a specific functional area such as the actual visual display, or as small as a single sub-pixel.

The term “modifying” and its variants is intended to mean a process under which a layer, material, or any combination thereof, is exposed to radiation and undergoes an irreversible change without introducing any additional material into such layer, material, or any combination thereof during the process.

The term “organic active film” is intended to mean an organic film, by itself, or when in contact with a dissimilar material, is capable of forming a rectifying junction.

The term “organic device layer” is intended to mean a layer that lies between electrodes within an electronic component and includes a charge-selective film, an organic active film, or any combination thereof.

The term “precision deposition technique” is intended to mean a deposition technique that is capable of depositing one or more materials over a substrate in a pattern to a thickness no greater than approximately one millimeter. A stencil mask, frame, well structure, patterned layer or other structure(s) may or may not be present during such deposition.

The term “radiation” is intended to mean energy in the form of waves or particles. Radiation may be within the visible-light spectrum, outside the visible-light spectrum (UV or IR). Radiation can also include radioactivity or another particle emission, such as an electron or other particle beam.

The term “radiation-emitting component” is intended to mean an electronic component, which when properly biased, emits radiation at a targeted wavelength or spectrum of wavelengths. The radiation may be within the visible-light spectrum or outside the visible-light spectrum (ultraviolet (“UV”) or infrared (“IR”)). A light-emitting diode is an example of a radiation-emitting component.

The term “radiation-responsive component” is intended to mean an electronic component, which when properly biased, can respond to radiation at a targeted wavelength or spectrum of wavelengths. The radiation may be within the visible-light spectrum or outside the visible-light spectrum (UV or IR). An IR sensor and a photovoltaic cell are examples of radiation-sensing components.

The term “radiation sensitizer” is intended to mean a compound or system of compounds which can absorb radiation and produce chemical changes in a material. In some embodiments, the radiation sensitizer absorbs radiation to form an excited state. The excited state transfers the energy to a second molecule to form an excited state in that second molecule. In some embodiments, the radiation sensitizer generates free radicals when exposed to radiation.

The term “resistivity” is the inverse of electrical conductivity. Resistivity is a measure of how strongly a material opposes the flow of electric current. A low resistivity indicates a material that readily allows the movement of elecrrical charge.

The term “small molecule,” when referring to a compound, is intended to mean a compound which does not have repeating monomeric units. In one embodiment, a small molecule has a molecular weight no greater than 2000 g/mol.

The term “ultra-violet” (“UV”) is intended to mean radiation that has an emission maximum at a wavelength less than approximately 360 nm. As used herein, x-rays are an example of ultra-violet radiation.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. The Radiation Sensitizer

In the process described herein, an organic device layer is formed and selectively exposed to radiation. The radiation sensitizer is a compound or system of compounds that absorbs the radiation used in the process. The absorption of the radiation by the radiation sensitizer results in chemical changes in the organic device layer. Because of the chemical changes, the electrical conductivity of the organic device layer is modified.

Any known radiation sensitive material which will effect a change in the organic device layer can be used as the radiation sensitizer. The sensitizer may be a single compound or a system of two or more compounds.

In some embodiments, the radiation sensitizer is a free radical generator. Such materials are well known in the art of photoresists and other photosensitive materials. Examples of these radiation sensitizers include, but are not limited to, compounds which undergo fragmentation, systems of compounds which generate radicals by hydrogen abstraction, and photoreducible dyes, such as acridinium, xanthene and thiazine dyes. Examples of radiation-sensitive materials which generate free radicals include, but are not limited to, quinones, benzophenones, benzoin ethers, aryl ketones, peroxides, biimidazoles, benzyl dimethyl ketal, hydroxyl alkyl phenyl acetophone, dialkoxy actophenone, trimethylbenzoyl phosphine oxide derivatives, aminoketones, benzoyl cyclohexanol, methyl thio phenyl morpholino ketones, morpholino phenyl amino ketones, alpha halogennoacetophenones, oxysulfonyl ketones, sulfonyl ketones, oxysulfonyl ketones, sulfonyl ketones, benzoyl oxime esters, thioxanthrones, camphorquinones, ketocoumarins, and Michler's ketone.

In some embodiments, the radiation sensitizer can be applied with the charge-selective material by a liquid deposition technique to form the organic device layer. In some embodiments, the radiation sensitizer is a small molecule which is volatile at temperatures between 50° C. and 200° C.

### 3. The Organic Device Layer

The organic device layer includes a charge-selective material and a radiation sensitizer.

In a particular embodiment, the organic device layer comprises hole-transport material.

Commonly used small molecule hole-transporting materials include, but are not limited to: 4,4′,4″-tris(N,N-diphenyl-amino)-triphenylamine (TDATA); 4,4′,4″-tris(N-3-methylphenyl-N-phenyl-amino)-triphenylamine (MTDATA); N,N′-diphenyl-N,N′-bis(3-methylphenyl)-[1,1′-biphenyl]-4,4′-diamine (TPD); 1,1-bis[(di-4-tolylamino) phenyl]cyclohexane (TAPC); N,N′-bis(4-methylphenyl)-N,N′-bis(4-ethylphenyl)-[1,1′-(3,3′-dimethyl)biphenyl]-4,4′-diamine (ETPD); tetrakis-(3-methylphenyl)-N,N,N′,N′-2,5-phenylenediamine (PDA); α-phenyl-4-N,N-diphenylaminostyrene (TPS); p-(diethylamino)benzaldehyde diphenylhydrazone (DEH); triphenylamine (TPA); bis[4-(N,N-diethylamino)-2-methylphenyl](4-methylphenyl)methane (MPMP); 1-phenyl-3-[p-(diethylamino)styryl]-5-[p-(diethylamino)phenyl] pyrazoline (PPR or DEASP); 1,2-trans-bis(9H-carbazol-9-yl)cyclobutane (DCZB); N,N,N′,N′-tetrakis(4-methylphenyl)-(1,1′-biphenyl)-4,4′-diamine (TTB); N,N′-bis(naphthalen-1-yl)-N,N′-bis-(phenyl)benzidine (α-NPB); and porphyrinic compounds, such as copper phthalocyanine.

Commonly used large molecule hole-transporting materials are polymers, such as polyvinylcarbazole, (phenylmethyl)-polysilane, and polyaniline. In some cases, triarylamine polymers are used, especially triarylamine-fluorene copolymers. In some cases, the polymers and copolymers are crosslinkable.

In some embodiments, the hole-transport polymer is a distyrylaryl compound. In some embodiments, the aryl group is has two or more fused aromatic rings. In some embodiments, the aryl group is an acene. The term “acene” as used herein refers to a hydrocarbon parent component that contains two or more ortho-fused benzene rings in a straight linear arrangement.

In some embodiments, the hole-transport polymer is an arylamine polymer. In some embodiments, it is a copolymer of fluorene and arylamine monomers.

In some embodiments, the polymer has crosslinkable groups. In some embodiments, crosslinking can be accomplished by a heat treatment and/or exposure to UV or visible radiation. Examples of crosslinkable groups include, but are not limited to vinyl, acrylate, perfluorovinylether, 1-benzo-3,4-cyclobutane, siloxane, and methyl esters. Crosslinkable polymers can have advantages in the fabrication of solution-process OLEDs. The application of a soluble polymeric material to form a layer which can be converted into an insoluble film subsequent to deposition, can allow for the fabrication of multilayer solution-processed OLED devices free of layer dissolution problems.

Examples of crosslinkable polymers can be found in, for example, published US patent application 2005-0184287 and published PCT application WO 2005/052027.

In some embodiments, the hole-transport layer comprises a polymer which is a copolymer of 9,9-dialkylfluorene and triphenylamine. In some embodiments, the polymer is a copolymer of 9,9-dialkylfluorene and 4,4′-bis(diphenylamino)biphenyl. In some embodiments, the polymer is a copolymer of 9,9-dialkylfluorene and TPB. In some embodiments, the polymer is a copolymer of 9,9-dialkylfluorene and NPB. In some embodiments, the copolymer is made from a third comonomer selected from (vinylphenyl)diphenylamine and 9,9-distyrylfluorene or 9,9-di(vinylbenzyl)fluorene.

The polymers for the hole-transport layer can generally be prepared by known synthetic routes, including Yamamoto and Suzuki coupling.

### 4. The Chemical Containment Pattern

The chemical containment pattern is formed over the organic device layer.

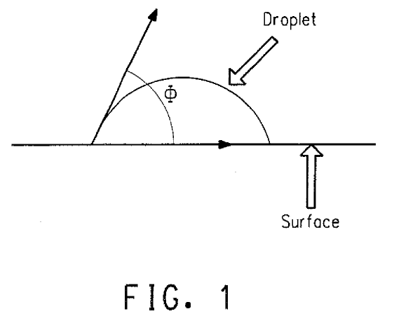

In some embodiments, the chemical containment pattern has lower surface energy than the surrounding areas. One way to determine the relative surface energies is to compare the contact angle of a given liquid on the first organic active layer before and after treatment with the RSA. As used herein, the term “contact angle” is intended to mean the angle φ shown in FIG. 1. For a droplet of liquid medium, angle φ is defined by the intersection of the plane of the surface and a line from the outer edge of the droplet to the surface. Furthermore, angle φ is measured after the droplet has reached an equilibrium position on the surface after being applied, i.e. “static contact angle”. A variety of manufacturers make equipment capable of measuring contact angles.

The chemical containment pattern can be a separate patterned layer, or it can be a surface treatment in a pattern.

When the chemical containment pattern is present as a separate layer, it is an ultra-thin layer. In some embodiments, the layer has a thickness no greater than 500 Å; in some embodiments, no greater than 100 Å; in some embodiments, no greater than 50 Å. In some embodiments, the pattern is a monolayer.

In some embodiments, the chemical containment pattern is a layer of low surface energy material which is deposited in a pattern. Materials such as silicon fluorides or silicon nitrides can be applied in a pattern by vapor deposition. Materials such as fluorocarbons or silicones can be applied in a pattern using standard photolithographic techniques. In some embodiments, the chemical containment pattern is formed by treatment of the immediate underlying layer with a reactive surface-active composition. The reactive surface-active composition (“RSA”) is a radiation-sensitive composition. When exposed to radiation, at least one physical property and/or chemical property of the RSA is changed such that the exposed and unexposed areas can be physically differentiated and a pattern can be formed. Treatment with the RSA lowers the surface energy of the material being treated.

In one embodiment, the RSA is a radiation-hardenable composition. In this case, when exposed to radiation, the RSA can become more soluble or dispersable in a liquid medium, less tacky, less soft, less flowable, less liftable, or less absorbable. Other physical properties may also be affected.

In one embodiment, the RSA is a radiation-softenable composition. In this case, when exposed to radiation, the RSA can become less soluble or dispersable in a liquid medium, more tacky, more soft, more flowable, more liftable, or more absorbable. Other physical properties may also be affected.

The radiation can be any type of radiation which results in a physical change in the RSA. In one embodiment, the radiation is selected from infrared radiation, visible radiation, ultraviolet radiation, and combinations thereof.

Physical differentiation between areas of the RSA exposed to radiation and areas not exposed to radiation, hereinafter referred to as “development,” can be accomplished by any known technique. Such techniques have been used extensively in the photoresist art. Examples of development techniques include, but are not limited to, application of heat (evaporation), treatment with a liquid medium (washing), treatment with an absorbant material (blotting), treatment with a tacky material, and the like.

In one embodiment, the RSA consists essentially of one or more radiation-sensitive materials. In one embodiment, the RSA consists essentially of a material which, when exposed to radiation, hardens, or becomes less soluble, swellable, or dispersible in a liquid medium, or becomes less tacky or absorbable. In one embodiment, the RSA consists essentially of a material having radiation polymerizable groups. Examples of such groups include, but are not limited to olefins, acrylates, methacrylates and vinyl ethers. In one embodiment, the RSA material has two or more polymerizable groups which can result in crosslinking. In one embodiment, the RSA consists essentially of a material which, when exposed to radiation, softens, or becomes more soluble, swellable, or dispersible in a liquid medium, or becomes more tacky or absorbable. In one embodiment, the RSA consists essentially of at least one polymer which undergoes backbone degradation when exposed to deep UV radiation, having a wavelength in the range of 200-300 nm. Examples of polymers undergoing such degradation include, but are not limited to, polyacrylates, polymethacrylates, polyketones, polysulfones, copolymers thereof, and mixtures thereof.

In one embodiment, the RSA consists essentially of at least one reactive material and at least one radiation-sensitive material. The radiation-sensitive material, when exposed to radiation, generates an active species that initiates the reaction of the reactive material. Examples of radiation-sensitive materials include, but are not limited to, those that generate free radicals, acids, or combinations thereof. In one embodiment, the reactive material is polymerizable or crosslinkable. The material polymerization or crosslinking reaction is initiated or catalyzed by the active species. The radiation-sensitive material is generally present in amounts from 0.001% to 10.0% based on the total weight of the RSA.

In one embodiment, the RSA consists essentially of a material which, when exposed to radiation, hardens, or becomes less soluble, swellable, or dispersible in a liquid medium, or becomes less tacky or absorbable. In one embodiment, the reactive material is an ethylenically unsaturated compound and the radiation-sensitive material generates free radicals. Ethylenically unsaturated compounds include, but are not limited to, acrylates, methacrylates, vinyl compounds, and combinations thereof. Any of the known classes of radiation-sensitive materials that generate free radicals can be used. In one embodiment, the radiation sensitive material is sensitive to visible or ultraviolet radiation.

In one embodiment, the RSA is a compound having one or more crosslinkable groups. Crosslinkable groups can have moieties containing a double bond, a triple bond, a precursor capable of in situ formation of a double bond, or a heterocyclic addition polymerizable group. Some examples of crosslinkable groups include benzocyclobutane, azide, oxiran, di(hydrocarbyl)amino, cyanate ester, hydroxyl, glycidyl ether, C1-10 alkylacrylate, C1-10 alkylmethacrylate, alkenyl, alkenyloxy, alkynyl, maleimide, nadimide, tri(C1-4)alkylsiloxy, tri(C1-4)alkylsilyl, and halogenated derivatives thereof. In one embodiment, the crosslinkable group is selected from the group consisting of vinylbenzyl, p-ethenylphenyl, perfluoroethenyl, perfluoroehtenyloxy, benzo-3,4-cyclobutan-1-yl, and p-(benzo-3,4-cyclobutan-1-yl)phenyl.

In one embodiment, the reactive material can undergo polymerization initiated by acid, and the radiation-sensitive material generates acid. Examples of such reactive materials include, but are not limited to, epoxies. Examples of radiation-sensitive materials which generate acid, include, but are not limited to, sulfonium and iodonium salts, such as diphenyliodonium hexafluorophosphate.

In one embodiment, the RSA consists essentially of a material which, when exposed to radiation, softens, or becomes more soluble, swellable, or dispersible in a liquid medium, or becomes more tacky or absorbable. In one embodiment, the reactive material is a phenolic resin and the radiation-sensitive material is a diazonaphthoquinone.

Other radiation-sensitive systems that are known in the art can be used as well.

In one embodiment, the RSA comprises a fluorinated material. In one embodiment, the RSA comprises an unsaturated material having one or more fluoroalkyl groups. In one embodiment, the fluoroalkyl groups have from 2-20 carbon atoms. In one embodiment, the RSA is a fluorinated acrylate, a fluorinated ester, or a fluorinated olefin monomer. Examples of commercially available materials which can be used as RSA materials, include, but are not limited to, Zonyl® 8857A, a fluorinated unsaturated ester monomer available from E. I. du Pont de Nemours and Company (Wilmington, Del.), and 3,3,4,4,5,5,6,6,7,7,8,8,9,9,10,10,11,11,12,12,12-heneicosafluorododecyl acrylate (H₂C═CHCO₂CH₂CH₂(CF₂)₉CF₃) available from Sigma-Aldrich Co. (St. Louis, Mo.).

In one embodiment, the RSA is a fluorinated macromonomer. As used herein, the term “macromonomer” refers to an oligomeric material having one or more reactive groups which are terminal or pendant from the chain. In some embodiments, the macromonomer has a molecular weight greater than 1000; in some embodiments, greater than 2000; in some embodiments, greater than 5000. In some embodiments, the backbone of the macromonomer includes ether segments and perfluoroether segments. In some embodiments, the backbone of the macromonomer includes alkyl segments and perfluoroalkyl segments. In some embodiments, the backbone of the macromonomer includes partially fluorinated alkyl or partially fluorinated ether segments. In some embodiments, the macromonomer has one or two terminal polymerizable or crosslinkable groups.

In one embodiment, the RSA is an oligomeric or polymeric material having cleavable side chains, where the material with the side chains forms films with a different surface energy that the material without the side chains. In one embodiment, the RSA has a non-fluorinated backbone and partially fluorinated or fully fluorinated side chains. The RSA with the side chains will form films with a lower surface energy than films made from the RSA without the side chains. Thus, the RSA can be can be applied to an immediate underlying layer, exposed to radiation in a pattern to cleave the side chains, and developed to remove the side chains. This results in a pattern of higher surface energy in the areas exposed to radiation where the side chains have been removed, and lower surface energy in the unexposed areas where the side chains remain. In some embodiments, the side chains are thermally fugitive and are cleaved by heating, as with an infrared laser. In this case, development may be coincidental with exposure in infrared radiation. Alternatively, development may be accomplished by the application of a vacuum or treatment with solvent. In some embodiment, the side chains are cleavable by exposure to UV radiation. As with the infrared system above, development may be coincidental with exposure to radiation, or accomplished by the application of a vacuum or treatment with solvent.

In one embodiment, the RSA comprises a material having a reactive group and second-type functional group. The second-type functional groups can be present to modify the physical processing properties or the photophysical properties of the RSA. Examples of groups which modify the processing properties include plasticizing groups, such as alkylene oxide groups. Examples of groups which modify the photophysical properties include charge transport groups, such as carbazole, triarylamino, or oxadiazole groups.

In one embodiment, the RSA reacts with the immediate underlying area when exposed to radiation. The exact mechanism of this reaction will depend on the materials used. After exposure to radiation, the RSA is removed in the unexposed areas by a suitable development treatment. In some embodiments, the RSA is removed only in the unexposed areas. In some embodiments, the RSA is partially removed in the exposed areas as well, leaving a thinner layer in those areas. In some embodiments, the RSA that remains in the exposed areas is no greater than 50 Å in thickness. In some embodiments, the RSA that remains in the exposed areas is essentially a monolayer in thickness.

In one embodiment, the RSA is applied as a separate layer overlying, and in direct contact with, the organic device layer.

In one embodiment, the RSA is applied without adding it to a solvent. In one embodiment, the RSA is applied by vapor deposition. In one embodiment, the RSA is a liquid at room temperature and is applied by liquid deposition over the immediate underlying layer. The liquid RSA may be film-forming or it may be absorbed or adsorbed onto the surface of the immediate underlying layer. In one embodiment, the liquid RSA is cooled to a temperature below its melting point in order to form a second layer over the immediate underlying layer. In one embodiment, the RSA is not a liquid at room temperature and is heated to a temperature above its melting point, deposited on the immediate underlying layer, and cooled to room temperature to form a second layer over the immediate underlying layer. For the liquid deposition, any of the methods described above may be used.

In one embodiment, the RSA is deposited from a second liquid composition. The liquid deposition method can be continuous or discontinuous, as described above. In one embodiment, the RSA liquid composition is deposited using a continuous liquid deposition method. The choice of liquid medium for depositing the RSA will depend on the exact nature of the RSA material itself. In one embodiment, the RSA is a fluorinated material and the liquid medium is a fluorinated liquid. Examples of fluorinated liquids include, but are not limited to, perfluorooctane, trifluorotoluene, and hexafluoroxylene.

In some embodiments, the RSA treatment comprises a first step of forming a sacrificial layer over the underlying layer, and a second step of applying an RSA layer over the sacrificial layer. The sacrificial layer is one which is more easily removed than the RSA layer by whatever development treatment is selected. Thus, after exposure to radiation, as discussed below, the RSA layer and the sacrificial layer are removed in either the exposed or unexposed areas in the development step. The sacrificial layer is intended to facilitate complete removal of the RSA layer is the selected areas and to protect the underlying immediate underlying layer from any adverse affects from the reactive species in the RSA layer.

After the RSA treatment, the treated layer is exposed to radiation. The type of radiation used will depend upon the sensitivity of the RSA as discussed above. The exposure is patternwise. As used herein, the term “patternwise” indicates that only selected portions of a material or layer are exposed. Patternwise exposure can be achieved using any known imaging technique. In one embodiment, the pattern is achieved by exposing through a mask. In one embodiment, the pattern is achieved by exposing only select portions with a laser. The time of exposure can range from seconds to minutes, depending upon the specific chemistry of the RSA used. When lasers are used, much shorter exposure times are used for each individual area, depending upon the power of the laser. The exposure step can be carried out in air or in an inert atmosphere, depending upon the sensitivity of the materials.

In one embodiment, the radiation is selected from the group consisting of ultra-violet radiation (10-390 nm), visible radiation (390-770 nm), infrared radiation (770-106 nm), and combinations thereof, including simultaneous and serial treatments. In one embodiment, the radiation is deep UV radiation, having a wavelength in the range of 200-300 nm. In another embodiment, the ultraviolet radiation is of somewhat longer wavelength, in the range 300-400 nm. In one embodiment, the radiation is thermal radiation. In one embodiment, the exposure to radiation is carried out by heating. The temperature and duration for the heating step is such that at least one physical property of the RSA is changed, without damaging any underlying layers of the light-emitting areas. In one embodiment, the heating temperature is less than 250° C. In one embodiment, the heating temperature is less than 150° C.

In one embodiment, the radiation is ultraviolet or visible radiation. In one embodiment, the radiation is applied patternwise, resulting in exposed regions of RSA and unexposed regions of RSA.

In one embodiment, patternwise exposure to radiation is followed by treatment to remove either the exposed or unexposed regions of the RSA. Patternwise exposure to radiation and treatment to remove exposed or unexposed regions is well known in the art of photoresists.

In one embodiment, the exposure of the RSA to radiation results in a change in the solubility or dispersibility of the RSA in solvents. When the exposure is carried out patternwise, this can be followed by a wet development treatment. The treatment usually involves washing with a solvent which dissolves, disperses or lifts off one type of area. In one embodiment, the patternwise exposure to radiation results in insolubilization of the exposed areas of the RSA, and treatment with solvent results in removal of the unexposed areas of the RSA.

In one embodiment, the exposure of the RSA to visible or UV radiation results in a reaction which decreases the volatility of the RSA in exposed areas. When the exposure is carried out patternwise, this can be followed by a thermal development treatment. The treatment involves heating to a temperature above the volatilization or sublimation temperature of the unexposed material and below the temperature at which the material is thermally reactive. For example, for a polymerizable monomer, the material would be heated at a temperature above the sublimation temperature and below the thermal polymerization temperature. It will be understood that RSA materials which have a temperature of thermal reactivity that is close to or below the volatilization temperature, may not be able to be developed in this manner.

In one embodiment, the exposure of the RSA to radiation results in a change in the temperature at which the material melts, softens or flows. When the exposure is carried out patternwise, this can be followed by a dry development treatment. A dry development treatment can include contacting an outermost surface of the element with an absorbent surface to absorb or wick away the softer portions. This dry development can be carried out at an elevated temperature, so long as it does not further affect the properties of the originally unexposed areas.

After treatment with the RSA, exposure to radiation, and development, there is a pattern on the immediate underlying layer having areas of low surface energy and areas of higher surface energy. In the case where part of the RSA is removed after exposure to radiation, the areas of the immediate underlying layer that are covered by the RSA will have a lower surface energy that the areas that are not covered by the RSA. The chemical containment pattern defines pixel openings.

### 4. Fabrication of an Electronic Device

One example of an electronic device is an organic light-emitting diode (“OLED”). Such devices have a light-emitting layer positioned between two electrodes, and can have one or more charge-selective layers between the light-emitting layer and either electrode. The charge-selective layers can comprises charge-injecting, charge-transporting and/or charge-blocking materials, and are generally electrically conductive. When these materials are present in regions outside the active pixel areas, they can carry undesired currents, detracting from the electrical efficiency of the pixel. In addition, if any emissive materials are present outside the pixel area, a secondary emissive diode can be formed and contribute undesired color to the display. Furthermore, the charge-selective layers may contribute to undesirable cross-talk from pixel to pixel. The process described herein can be used to decrease the electrical conductivity of at least one of the charge-selective layers so that these problems are significantly reduced or eliminated.

In a second aspect, an electronic device can include a first pixel including a first electrode, a first portion of the organic device layer, and a first organic active film. The first pixel can also include a first portion of a common electrode, wherein the first portion of the organic device layer and the first organic active film lie between the first electrode and the first portion of the common electrode, and the organic device layer includes not more than 15 mole percent basic material. The electronic device can also include a second pixel including a second electrode, a second portion of the organic device layer, and a second organic active film. The second pixel can also include a second portion of the common electrode, wherein the second portion of the organic device layer and the second organic active film lie between the second electrode and the second portion of the common electrode. The electronic device can further include a third pixel including a third electrode, a third portion of the organic device layer, and a third organic active film. The third pixel can also include a third portion of the common electrode, wherein the third portion of the organic device layer and the third organic active film lie between the third electrode and the third portion of the common electrode. The electronic device can still further include a fourth portion of the organic device layer lying between the first pixel and the second pixel, and having a higher resistivity than each of the first portion and the second portion of the organic device layer. The electronic device can yet further include a fifth portion of the organic device layer lying between the second pixel and the third pixel, and having a higher resistivity than each of the second portion and the third portion of the organic device layer.

In a particular embodiment, the first portion of the organic device layer lies between the first electrode and second electrode. In a more particular embodiment, the electronic device can further include a first organic active film, wherein the organic device layer lies between the first organic active film and the first electrode. In an even more particular embodiment, the electronic device can further include a substrate, wherein the first electrode and the second electrode each lie between the organic device layer and the substrate. In a still more particular embodiment, the second portion of the organic device layer overlies the first electrode.

In an even more particular embodiment, the electronic device can further include a second organic active film overlying the second electrode and the organic device layer, wherein substantially none of the first organic active film overlies the second electrode, and substantially none of the second organic active film overlies the first electrode. Also, the first organic active film and the second organic active film overlie the first portion of the organic device layer.

In another even more particular embodiment, the electronic device can further include a second organic active film overlying the second electrode and a third portion of the organic device layer. Substantially none of the first organic active film can overlie the second electrode, substantially none of the second organic active film can overlie the first electrode, and the first organic active film can overlie the second portion of the organic device layer. The first portion of the organic device layer can lie between the second portion and the third portion of the organic device layer, and the third portion of the organic device layer can have a lower resistivity than the first portion of the organic device layer. In another particular embodiment, the organic device layer and the first organic active film lie between the first and second electrodes.

In one embodiment, an electronic device can include a first pixel including a first electrode, a first portion of a organic device layer, and a first organic active film. The first pixel can also include a first portion of a common electrode, wherein the first portion of the organic device layer and the first organic active film lie between the first electrode and the first portion of the common electrode, and the organic device layer includes not more than 15 mole percent basic material. The electronic device can also include a second pixel including a second electrode, a second portion of the organic device layer, and a second organic active film. The second pixel can also include a second portion of the common electrode, wherein the second portion of the organic device layer and the second organic active film lie between the second electrode and the second portion of the common electrode. The electronic device can further include a third pixel including a third electrode, a third portion of the organic device layer, and a third organic active film. The third pixel can also include a third portion of the common electrode, wherein the third portion of the organic device layer and the third organic active film lie between the third electrode and the third portion of the common electrode. The electronic device can still further include a fourth portion of the organic device layer lying between the first pixel and the second pixel, and having a higher resistivity than each of the first portion and the second portion of the organic device layer. The electronic device can yet further include a fifth portion of the organic device layer lying between the second pixel and the third pixel, and having a higher resistivity than each of the second portion and the third portion of the organic device layer.

FIG. 2 includes an illustration of a cross-sectional view of a workpiece 10 including a substrate 12. In the illustrated embodiment, the workpiece 10 includes electrodes 14, 16, and 18, and an organic device layer 110.

The substrate 12 can be either rigid or flexible and may include one or more layers of one or more materials such as glass, polymer, metal or ceramic materials, or combinations thereof. In one embodiment, the substrate 12 is substantially transparent to a targeted wavelength or spectrum of wavelengths associated with the electronic device. Pixel control or other circuits (not illustrated) can be formed within or over the substrate 12 using conventional or proprietary techniques.

In the illustrated embodiment, the electrodes 14, 16, and 18 serve as electrodes for electronic components, such as OLEDs. In one embodiment, the electrodes 14, 16, and 18 are anodes and have a work function of approximately 4.4 eV or higher. In a particular embodiment, the electrodes 14, 16, and 18 can include InSnO, InZnO, AlZnO, AlSnO, ZrSnO, another suitable material used for an anode in an OLED, or any combination thereof. The electrodes 14, 16, and 18 have a thickness in a range of approximately 10 to 1000 nm. The electrodes 14, 16, and 18 are formed by a deposition using a conventional or proprietary technique. The electrodes 14, 16, and 18 may include the same material or different materials, have the same or different thicknesses, be formed using the same or different technique, be formed at the same or different time, or any combination thereof.

Although not illustrated, a structure (e.g., a well structure, cathode separators, or the like) may lie adjacent to the electrode 14, 16, 18, or any combination thereof to reduce the likelihood of materials from different organic active layers from contacting each other at locations above the electrode 14, 16, 18, or any combination thereof.

The organic device layer 110, as discussed above, is formed over the electrodes 14, 16, and 18. The organic device layer 110 has a thickness in a range of approximately 50 to 500 nm, and in another embodiment, can be thicker or thinner than the recited range. Any individual or combination of films within the organic device layer 110 can be formed by a conventional or proprietary deposition technique and may be cured after deposition. In one embodiment, the organic device layer 110 is formed by a liquid deposition technique.

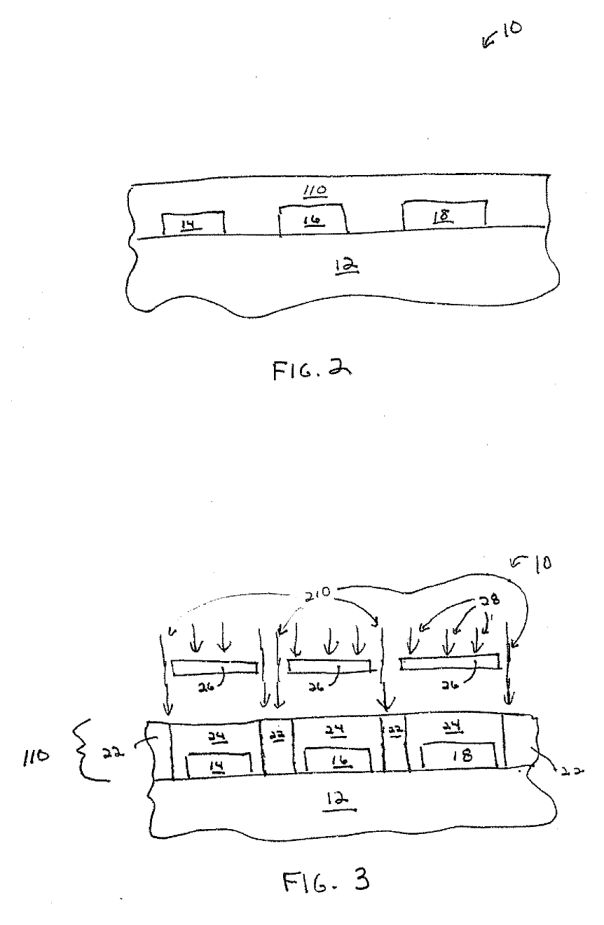

FIG. 3 includes an illustration of the workpiece 10 while selectively modifying the organic device layer 110. In the illustrated embodiment, selectively modifying includes selectively exposing a first portion 22 of the organic device layer 110 to radiation 210. The workpiece 10 is arranged such that a stencil mask 26 lies between a radiation source (not illustrated) and the workpiece 10. Radiation 210 is unattenuated and reaches the first portion 22 of the layer 110. Radiation 28 is attenuated and substantially prevented from reaching a second portion 24 of the organic device layer 110 by the stencil mask 26. In a particular embodiment, wavelength of the radiation 210 has a value not greater than approximately 360 nm. In a more particular embodiment, the radiation 210 includes UV-A radiation, UV-B radiation, UV-C radiation, or any combination thereof. In an even more particular embodiment, the radiation 210 is UV-C radiation with a wavelength in a range of approximately 200 to approximately 280 nm.

In another particular embodiment, the radiation 210 has a peak intensity of at least 10 J/cm² at the surface of the organic device layer 110. In another embodiment, the radiation 210 can include a particle beam (e.g., an electron beam). In still another embodiment, selectively modifying the organic device layer 110 is performed in an environment with an oxygen-containing material, such as oxygen, water, an alcohol, a glycol, another oxygen-containing organic material, or any combination thereof. In one embodiment, the oxygen-containing material lies within the organic device layer 210 or an immediately adjacent layer.

After selective modification of the organic device layer 110, the first portion 22 has a higher resistivity than the second portion 24. In a particular embodiment, the first portion 22 has a resistivity at least two orders of magnitude higher than the second portion 24. In a more particular embodiment, a substantially insulating pattern is formed by the first portion 22 within the organic device layer 110.

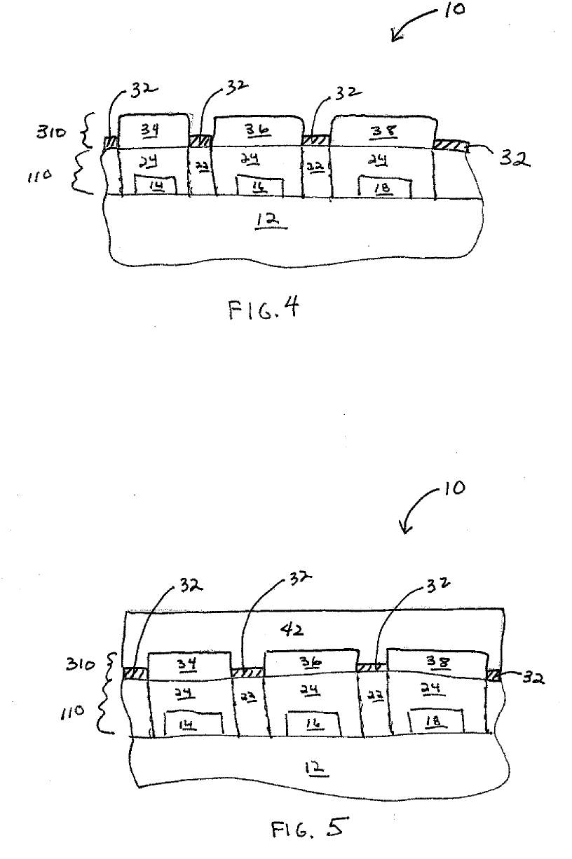

FIG. 4 includes an illustration of the workpiece 10 after forming a chemical containment pattern 32 and an organic active layer 310. In the illustrated embodiment, the organic active layer 310 includes an organic active layer 34 over the electrode 14, an organic active layer 36 over the electrode 16, and an organic active layer 38 over the electrode 18, where the active layers are contained within the open areas of the chemical containment pattern 32. Each of the organic active layer 34, the organic active layer 36, and the organic active layer 38 serves as an electroluminescent (“EL”) layer in an OLED and emits radiation. In one embodiment, the organic active layer 34, 36, 38, or any combination thereof emits a portion of the visible light spectrum. In another embodiment, the organic active layer 34, 36, 38, or any combination thereof emits a portion of the UV spectrum, the IR spectrum, or any combination thereof. In a more particular embodiment, each of the organic active layers 34, 36, and 38 includes different radiation-emitting materials and emit a significantly different spectrum of light as compared to the other organic active layers of the organic active layer 310. In yet another embodiment, the organic active layer 34, 36, 38, or any combination thereof is used in a radiation-responsive component, such as a radiation sensor, photovoltaic cell, or the like.

The organic active layer 34, 36, 38, or any combination thereof include material(s) conventionally used as organic active layers in organic electronic devices and can include a small molecule material, a large molecule material, or any combination thereof, including small molecule organic fluorescent compounds, fluorescent and phosphorescent metal complexes, conjugated polymers, and mixtures thereof. Examples of fluorescent compounds include, but are not limited to, pyrene, perylene, rubrene, coumarin, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of iridium with phenylpyridine, phenylquinoline, or phenylpyrimidine ligands as disclosed in Petrov et al., U.S. Pat. No. 6,670,645 and Published PCT Applications WO 03/063555 and WO 2004/016710, and organometallic complexes described in, for example, Published PCT Applications WO 03/008424, WO 03/091688, and WO 03/040257, and mixtures thereof. Electroluminescent emissive layers comprising a charge carrying host material and a metal complex have been described by Thompson et al., in U.S. Pat. No. 6,303,238, and by Burrows and Thompson in published PCT applications WO 00/70655 and WO 01/41512. Examples of conjugated polymers include, but are not limited to poly(phenylenevinylenes), polyfluorenes, poly(spirobifluorenes), polythiophenes, poly(p-phenylenes), copolymers thereof, and mixtures thereof.

The organic active layer 34, 36, 38, or any combination thereof has a thickness in a range of approximately 40 to 100 nm, and in a particular embodiment, a thickness in a range of approximately 70 to 90 nm. In another embodiment, each of the organic active layers 34, 36, and 38 has the same or different thickness as compared to the other organic active layers of the organic active layer 310.

The organic active layer 34, 36, 38, or any combination thereof is deposited using a conventional or proprietary deposition technique. In a more particular embodiment, the deposition technique is a liquid deposition process including a precision deposition process, such as a continuous printing process, an ink-jet printing process, or the like. The organic active layer 34, 36, 38, or any combination thereof is formed using the same or different processes at the same or different time.

FIG. 5 includes an illustration of a cross-sectional view of a substantially complete electronic device including an electrode 42. In the illustrated embodiment, the electrode 42 serves as a cathode.

The electrode 42 can include a Group 1 metal, a Group 2 metal, a Group 12 metal, or any combination thereof. In a particular embodiment, the electrode 42 includes an element, alloy, salt, or any combination thereof containing a Group 1 element. In a more particular embodiment, the electrode 42 includes a lithium-containing material such as LiF, Li₂O, or any combination thereof. The electrode 42 can have a thickness in a range of approximately 20 to 2500 nm. The electrode 42 can be formed by a conventional or proprietary physical deposition technique and may include more than one layer. In one embodiment, the electrode 42 includes at least one layer deposited using a stencil mask.

Thus an electronic device is formed with an organic device layer 110 selectively modified to including a portion 22 with a higher resistivity than a portion 24. By using such a process, a conducting pathway is defined and charge-flux can be controlled within the electronic device without bank structures.

### 6. Other Device Layers

In some embodiments, a buffer layer is present between the electrode and the hole-transport layer. The term “buffer layer” or “buffer material” refers to electrically conductive or semiconductive materials and may have one or more functions in an organic electronic device, including but not limited to, planarization of the underlying layer, charge transport and/or charge injection properties, scavenging of impurities such as oxygen or metal ions, and other aspects to facilitate or to improve the performance of the organic electronic device. Buffer materials may be polymers, oligomers, or small molecules, and may be in the form of solutions, dispersions, suspensions, emulsions, colloidal mixtures, or other compositions.

The buffer layer is typically formed with polymeric materials, such as polyaniline (PANI) or polyethylenedioxythiophene (PEDOT), which are often doped with protonic acids. The protonic acids can be, for example, poly(styrenesulfonic acid), poly(2-acrylamido-2-methyl-1-propanesulfonic acid), and the like. The buffer layer 120 can comprise charge transfer compounds, and the like, such as copper phthalocyanine and the tetrathiafulvalene-tetracyanoquinodimethane system (TTF-TCNQ). In one embodiment, the buffer layer 120 is made from a dispersion of a conducting polymer and a colloid-forming polymeric acid. Such materials have been described in, for example, published U.S. patent applications 2004-0102577, 2004-0127637, and 2005/0205860.

The buffer layer can be applied by any deposition technique. In one embodiment, the buffer layer is applied by a solution deposition method, as described above. In one embodiment, the buffer layer is applied by a continuous solution deposition method.

In some embodiments, and electron transport/injection layer is present between the organic active layer and the cathode. This layer can function both to facilitate electron injection/transport, and can also serve as a confinement layer to prevent quenching reactions at layer interfaces. More specifically, the layer may promote electron mobility and reduce the likelihood of a quenching reaction if the organic active layer and cathode would otherwise be in direct contact. Examples of materials for this layer include, but are not limited to, metal-chelated oxinoid compounds (e.g., Alq₃ or the like); phenanthroline-based compounds (e.g., 2,9-dimethyl-4,7-diphenyl-1,10-phenanthroline (“DDPA”), 4,7-diphenyl-1,10-phenanthroline (“DPA”), or the like); azole compounds (e.g., 2-(4-biphenylyl)-5-(4-t-butylphenyl)-1,3,4-oxadiazole (“PBD” or the like), 3-(4-biphenylyl)-4-phenyl-5-(4-t-butylphenyl)-1,2,4-triazole (“TAZ” or the like); other similar compounds; or any one or more combinations thereof. Alternatively, the layer may be inorganic and comprise BaO, LiF, Li₂O, or the like.

In other embodiments, additional layer(s) may be present within organic electronic devices.

The different layers may have any suitable thickness. The inorganic anode layer is usually no greater than approximately 500 nm, for example, approximately 10-200 nm; the buffer layer and hole-transport layer are each usually no greater than approximately 250 nm, for example, approximately 50-200 nm; the organic active layer is usually no greater than approximately 1000 nm, for example, approximately 50-80 nm; the electron transport/injection layer is usually no greater than approximately 100 nm, for example, approximately 20-80 nm; and the cathode layer is usually no greater than approximately 100 nm, for example, approximately 1-50 nm.

The electronic device may be used by itself or may be incorporated into a system. For example, the electronic device can be a display that can be incorporated into a monitor for a computer, a television, or a display in a mobile communicating device, or the like.

The electronic device can be operated by providing the proper signals and data to the terminals as illustrated in FIG. 5. Appropriate voltages can be provided to the electrodes 14, 16, 18, and 42. In one embodiment, having radiation-emitting components, the electrodes 14, 16, and 18 are coupled to a V_{DD} power supply terminal, and the electrode 42 is coupled to a V_{SS} power supply terminal. In another embodiment, having radiation-responsive components (e.g. sensors), the electrode 42 can be placed at a more positive potential with respect to the electrodes 14, 16, and 18. In a particular embodiment, the electrode 42 can be at a potential of approximately 0 volts, and the electrodes 14, 16, and 18 can be at a potential of approximately −10 volts. When other types of electronic devices are formed (e.g., a photovoltaic array), the voltages or other signals may change accordingly.

### 7. Alternative Embodiments

Some materials used to form an organic device layer may be sensitive to exposure to atmospheric conditions. Using an overlying layer to protect such an exposure-sensitive layer during processing can reduce time constraints between manufacturing processes or widen the range of conditions under which subsequently performed processing can be successfully completed.

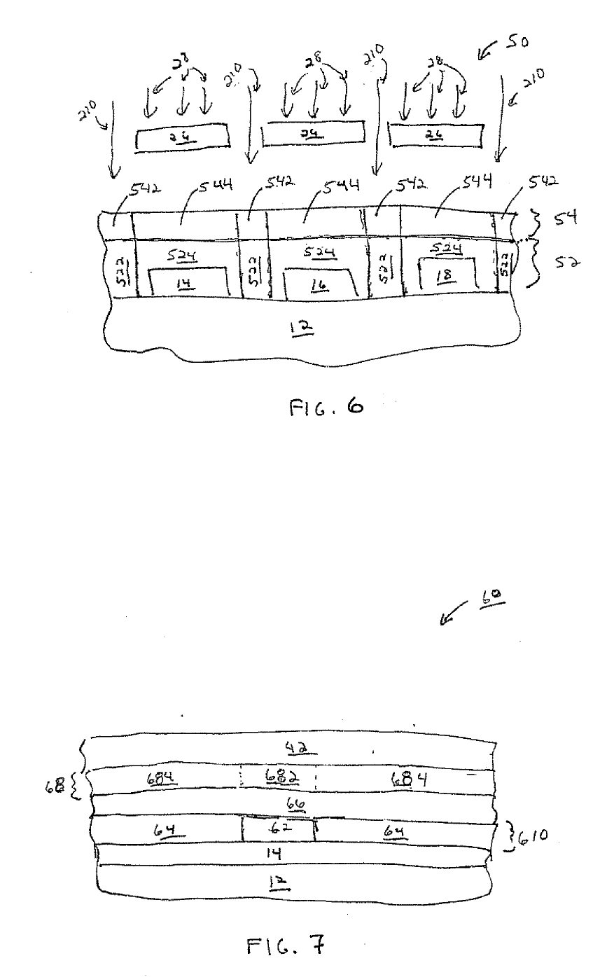

FIG. 6 includes an illustration of a cross-sectional view of a workpiece 50 according to a particular embodiment. The workpiece 50 includes a substrate 12 and electrodes 14, 16, and 18 as previously described with respect to the workpiece 10. The workpiece 50 also includes an organic device layer 52 and an organic device layer 54. The organic device layer 52 can be similar to the organic device layer 110 of the workpiece 10. In the illustrated embodiment, the organic device layer 52 is a hole-transport layer and can be sensitive to ambient conditions. An organic device layer 54 is deposited over the organic device layer 52. The organic device layer 54 is a second hole-transport layer and can serve to protect the organic device layer 52 during the manufacturing process. Each of the organic device layers 52 and 54 can be formed using an embodiment as previously described for the organic device layer 110 of the workpiece 10, and can include the same or different material as compared to each other. In the illustrated embodiment, an organic device layer 54 includes a material less sensitive to ambient conditions than the material of organic device layer 52. The material of the organic device layer 54 may not be affected by the subsequent exposure to the radiation 210.

The workpiece 50 is exposed to radiation as previously described with respect to the workpiece 10 in FIG. 3. A portion 522 of the organic device layer 52 and a portion 542 of the organic device layer 54 are exposed to radiation while the portion 524 of the organic device layer 52 and portion 544 of the organic device layer 54 are not. After the exposure, the portion 522 has a higher resistivity than the portion 524, and in one embodiment, the resistivity of the portion 542 remains substantially unchanged from before the exposure. In a particular embodiment, the organic device layer 52 is formed from an aqueous solution.

In other types of electronic devices, such as passive or static electronic displays, forming an organic device layer including a higher resistivity pattern that lies between an anode and a cathode of the electronic device can be useful to help control the current flow to an organic active layer. FIG. 7 includes an illustration of a cross-sectional view of a substantially complete device 60 according to a particular embodiment. The workpiece 60 includes a substrate 12, an electrode 14, and an electrode 42 as previously described for the workpiece 10. The workpiece 60 also includes an organic device layer 610, a charge-selective layer 66, and an organic active layer 68.

In the illustrated embodiment, an organic device layer 610 is deposited over the electrode 14. The organic device layer 610 is selectively modified in a manner similar to that previously described with respect to the organic device layer 110 of the workpiece 10 to form a first portion 62 and a second portion 64 similar to the first portion 22 and the second portion 24 of the organic device layer 110. Each of the first portion 62 and the second portion 64 lies between the electrode 14 and the subsequently formed electrode 42. The first portion 62 is radiation-exposed and has a higher resistivity than the second portion 64.

The charge-selective layer 66 is optional and may be used to improve device performance, or may serve a similar purpose to the protective layer 52 of the workpiece 50, in FIG. 6. The charge-selective layer 66 can be formed by an embodiment and using a material as previously described for the charge-selective layer 52. The organic active layer 68 is an EL layer. The organic active layer 68 can be formed by an embodiment and using materials as previously described for the organic active layer 310 of the workpiece 10.

In one embodiment, when in use, opposing charge types travel from each of the electrodes 14 and 42 towards the other electrode and can recombine within the organic active layer 68 to form radiation. In such a case, the relatively higher resistivity of the first portion 62 as compared to the second portion 64 can cause relatively fewer recombinations to take place within the region 682 as compared to the region 684. Thus within the organic active layer 68, the region 682 generates significantly less radiation than the region 684. In one embodiment, the region 682 generates substantially no radiation as compared to the region 684. In a particular embodiment, the electronic device 60 can act as a static display.

### EXAMPLES

The concepts described herein will be further described in the following examples, which do not limit the scope of the invention described in the claims.

### Example 1

This example illustrates the process described herein where the resisitivity of a hole-transport layer is increased.

The hole-transport material is a crosslinkable copolymer of triphenylamine, dioctyl fluorene, and distyryl fluorene (“HT-1)”.

The radiation sensitizer is Darocur® 1173 (Ciba Specialty Chemicals, Basel, Switzerland), which is an acetophenone derivative.

Backlight test displays will be made by coating sample solutions on to indium tin oxide coated glass substrates. Some of the displays will be exposed to UV light. The backlights will be baked at 275 C for 30 minutes to crosslink the HT-1, and simultaneously remove the Darocur® 1173, if present. The backlights will be covered with appropriate cathode layers of ZrQ then LiF then Al by vapor deposition, and then encapsulated to exclude air and water vapor. The resulting diodes represent the structure of the leakage paths in an actual display. A voltage will be applied, and the resulting electrical currents through these diodes will be measured.

Sample 1 is made with a solution of 0.3 g of HT-1 in toluene, without UV exposure.

Sample 2 is made with a solution of 0.3 g of HT-1 in toluene, with UV exposure.

Sample 3 is made with a solution of 0.3 g of HT-1 and 5 weight % Darocur® 1173, with UV exposure.

The current measured will be in the relative order:

Sample 1>Sample 2>Sample 3

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. For example, although the specification includes a description of a bottom emitting electronic device, after reading this specifications, skilled artisans should be able to form a top emitting electronic device without undue experimentation.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. The use of numerical values in the various ranges specified herein is stated as approximations as though the minimum and maximum values within the stated ranges were both being preceded by the word “about.” In this manner slight variations above and below the stated ranges can be used to achieve substantially the same results as values within the ranges. Also, the disclosure of these ranges is intended as a continuous range including every value between the minimum and maximum average values including fractional values that can result when some of components of one value are mixed with those of different value. Moreover, when broader and narrower ranges are disclosed, it is within the contemplation of this invention to match a minimum value from one range with a maximum value from another range and vice versa.

What is claimed is:

1. A process of forming an electronic device comprising:
forming an organic device layer that includes a charge-selective material and a radiation sensitizer, said layer having a first electrical conductivity; and
selectively exposing first portions of the organic device layer to radiation, wherein the electrical conductivity of the first portions of the organic device layer is modified.

2. The process of claim 1, wherein:
forming the organic device layer comprises forming a charge-selective film; and
selectively modifying the organic device layer is performed before forming another film on the charge-selective film.

3. The process of claim 1, wherein the radiation sensitizer is a UV sensitizer and selectively modifying the organic device layer comprises selectively exposing the organic device layer to a wavelength of radiation having a value not greater than 360 nm.

4. The process of claim 1, wherein selectively modifying the organic device layer is performed at a peak intensity of at least 10 J/cm² at a surface within the first portion of the organic device layer.

5. The process of claim 1, wherein the charge-selective material is hole-transport material.

6. The process of claim 1, wherein after selectively exposing the organic device layer, the first portions of the organic device layer have a lower conductivity than the remaining portions of the organic device layer.

7. The process of claim 1, further comprising forming over the organic device layer a chemical containment pattern defining pixel openings.

8. The process of claim 7, wherein the chemical containment pattern is formed by patterned surface treatment of the organic device layer.

9. The process of claim 7, wherein the chemical containment pattern comprises a separate layer deposited in a pattern over the organic device layer.

10. The process of claim 9, wherein the separate layer comprises an RSA material.

11. The process of claim 10, wherein the RSA material comprises a fluorinated material.

12. The process of claim 1, wherein the charge-selective material is a large molecule material.

13. A device comprising at least one organic device layer formed by the process of claim 1.

14. A process for forming an organic device layer including a charge-selective material and a radiation sensitizer, comprising:
forming a charge-selective film, and
selectively modifying the charge-selective film before forming another film on the charge-selective film.

15. The process of claim 14, wherein the radiation sensitizer is a UV sensitizer and selectively modifying the charge-selective film comprises selectively exposing the film to a wavelength of radiation having a value not greater than 360 nm.

16. The process of claim 14, wherein selectively modifying the charge-selective film is performed at a peak intensity of at least 10 J/cm² at a surface within the first portion of the organic device layer.

17. The process of claim 14, further comprising forming over the organic device layer a chemical containment pattern.

18. The process of claim 17, wherein the chemical containment pattern is formed by patterned surface treatment of the organic device layer.

19. The process of claim 17, wherein the chemical containment pattern comprises a separate layer deposited in a pattern over the organic device layer.

20. The process of claim 19, wherein the separate layer comprises an RSA material.

21. The process of claim 20, wherein the RSA material comprises a fluorinated material.

22. An organic device layer formed by the process of claim 14.
